(19) United States
(12) Patent Application Publication
(10) Pub. No.: US 2016/0162255 A1
(43) Pub. Date: Jun. 9, 2016

(54) ELECTRONIC DEVICE

(71) Applicant: KABUSHIKI KAISHA TOSHIBA, Tokyo (JP)

(72) Inventor: Masashi Nishimura, Ome Tokyo (JP)

(21) Appl. No.: 14/920,602

(22) Filed: Oct. 22, 2015

Related U.S. Application Data
(60) Provisional application No. 62/087,515, filed on Dec. 4, 2014.

(51) Int. Cl. G06F 3/16; H04R 5/04; H04R 3/04

(52) U.S. Cl. CPC G06F 3/165; H04R 3/04; H04R 5/04

(57) ABSTRACT

According to one embodiment, an electronic device includes a body and a display attached to the body configured to rotate between a state of covering a front surface of the body and a state of covering a back surface of the body, wherein the electronic device is placed in multiple configurations. An angle sensor measures an angle between the front surface and the display. A first sensor detects a configuration of the electronic device being placed. A processor corrects digital audio data based on the angle measured by the angle sensor and the configuration detected by the first sensor. Speakers output sound corresponding to the corrected digital audio data.

### CROSS-REFERENCE TO RELATED APPLICATIONS

This application claims the benefit of U.S. Provisional Application No. 62/087,515, filed Dec. 4, 2014, the entire contents of which are incorporated herein by reference.

### FIELD

Embodiments described herein relate generally to an electronic device designed to be used in various configurations.

### BACKGROUND

Recently, two-in-one personal computers designed to be used in two configurations, namely, notebook configuration and a tablet configuration have appeared on the market. Two-in-one computers include a computer having a hinge rotatable through 360 degrees. Two-in-one computer with a 360-degree hinge is designed to be used not only in notebook and tablet configurations but also in stand and tent configurations. In the stand configuration, the angle between the back of the display and the back of the keyboard is set to be acute. Further, the keyboard is placed on a supporting surface, and the screen is directed to the user. In the tent configuration, as in the stand configuration, the angle between the back of the display and the back of the keyboard is set to be acute. Further, a housing including the display and a housing including the keyboard are placed on the supporting surface.

Such a two-in-one computer can be used in various configurations. However, the positional relationship between the user and speakers varies from one configuration to another, and thus there are some cases where it is difficult for the user to hear sound output from the speakers.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective diagram showing an exterior appearance of an electronic device of an embodiment.

FIG. 2 is another exemplary perspective diagram showing an exterior appearance of an electronic device of an embodiment.

FIG. 3 is still another exemplary perspective diagram showing an exterior appearance of an electronic device of an embodiment.

FIG. 4 is still another exemplary perspective diagram showing an exterior appearance of an electronic device of an embodiment.

FIG. 5 is an exemplary block diagram showing a system configuration of an embodiment.

FIG. 6 is an exemplary functional block diagram showing a configuration to perform audio correction of an embodiment.

FIG. 7 is an exemplary view of a table showing a setting based on a value measured by an angle sensor and on a value measured by an acceleration sensor.

FIG. 8 is an exemplary view of a table showing a setting based on a value measured by the angle sensor and on a value measured by an illuminance sensor.

FIG. 9 is an exemplary flowchart for explaining the process from obtaining values measured by the sensors (angle sensor and acceleration sensor) to performing audio correction.

FIG. 10 is an exemplary flowchart for explaining the process from obtaining values measured by the sensors (angle sensor and illuminance sensor) to performing audio correction.

### DETAILED DESCRIPTION

Various embodiments will be described hereinafter with reference to the accompanying drawings.

In general, according to one embodiment, an electronic device includes a body and a display attached to the body configured to rotate between a state of covering a front surface of the body and a state of covering a back surface of the body, wherein the electronic device is placed in multiple configurations. The electronic device includes an angle sensor, a first sensor, a processor and speakers. The angle sensor measures an angle between the front surface and the display. The first sensor detects a configuration of the electronic device being placed. The processor corrects digital audio data based on the angle measured by the angle sensor and the configuration detected by the first sensor. The speakers output sound corresponding to the corrected digital audio data.

Various embodiments will be described hereinafter with reference to accompanying drawings.

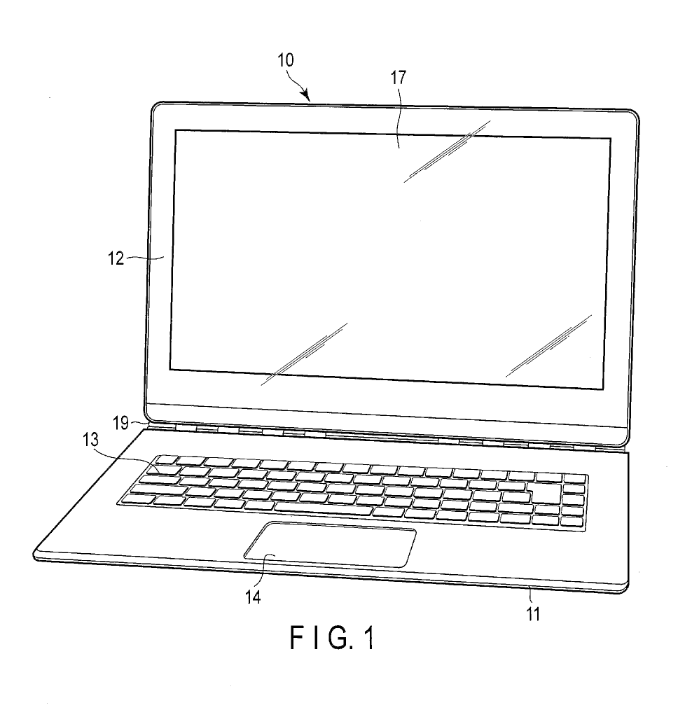

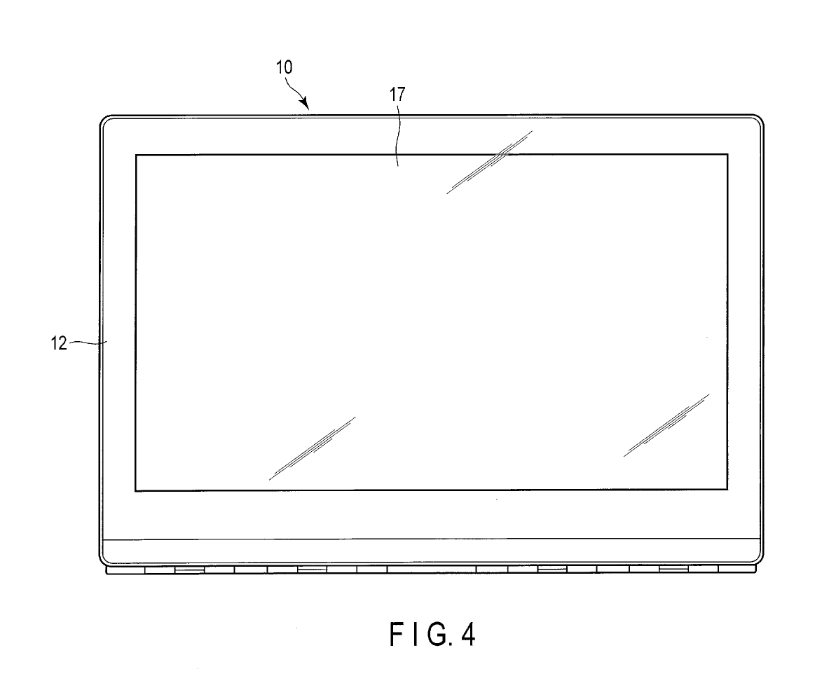

FIGS. 1 to 4 are drawings of the exterior appearance of an electronic device of an embodiment used respectively in a notebook configuration, a stand configuration, a tent configuration and a tablet configuration. The electronic device is realized as, for example, a two-in-one personal computer (hereinafter may be referred to as a computer as well) 10. The two-in-one computer 10 is used in a configuration corresponding to a notebook mode (notebook configuration) shown in FIG. 1 or a tablet mode (tablet configuration) shown in FIG. 4.

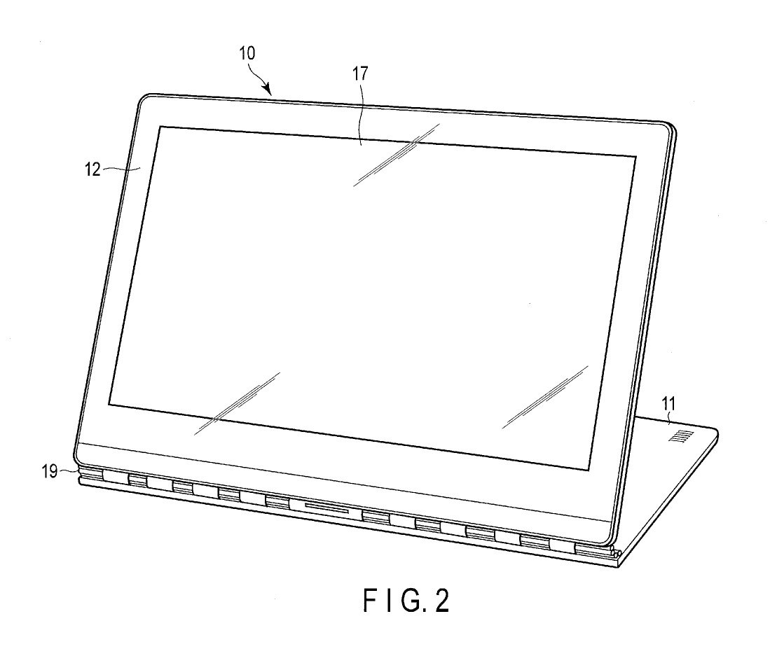

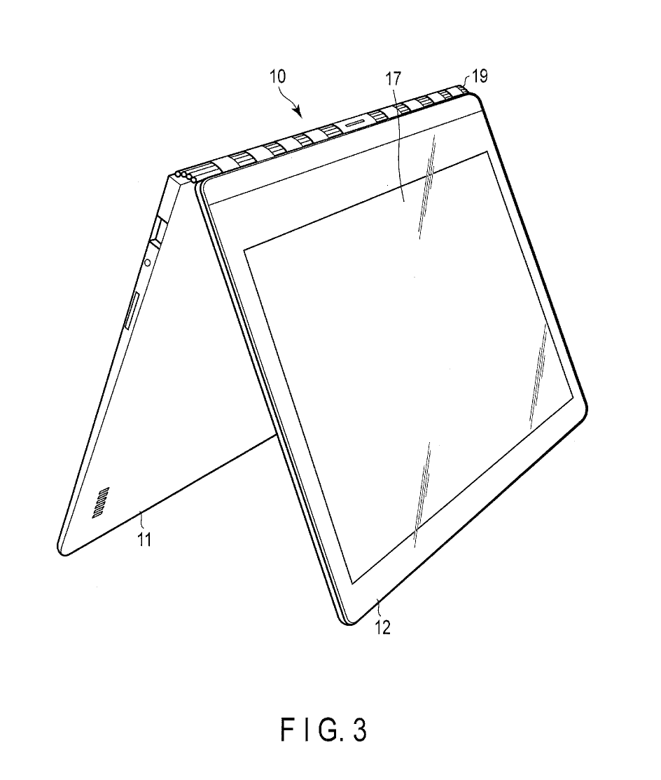

FIG. 1 illustrates the exterior appearance of the computer 10 used in the notebook configuration. FIG. 2 illustrates the exterior appearance of the computer 10 used in the stand configuration. FIG. 3 illustrates the exterior appearance of the computer 10 used in the tent configuration. FIG. 4 illustrates the exterior appearance of the computer 10 used in the tablet configuration.

The computer 10 comprises a body 11 and a display unit 12. The body 11 comprises a thin rectangular housing configured to accommodate a keyboard, a battery, and the like. On the upper surface (also called front surface) of the body 11, a keyboard 13 and a touchpad 14 as a pointing device are provided. The touchpad 14 is provided in a palm rest area on the upper surface of the body 11. At the back of the body 11, a hinge 19 configured to couple the body 11 and the display unit 12 together is provided.

The display unit 12 is attached to the computer body 11 in such a manner as to rotate between a state of covering the upper surface of the computer body 11 and a state of covering the lower surface (also called back surface) of the computer body 11. The computer body 11 comprises a thin box-shaped housing, and on the upper surface thereof, the keyboard 13, the touchpad 14, and the like are provided.

At the front of the display unit 12, that is, on the display surface of the display unit 12, a display 17 is provided. The display 17 is realized as a touchscreen display configured to detect the position of a stylus or a finger on the screen of the display 17.

In the notebook configuration, the computer 10 is used mostly in such a state of being placed on a horizontal plane of a desk or the like. The user mainly operates the keyboard 13 in a manner similar to that of the ordinary notebook computer.

In the tablet configuration, the computer 10 is used mostly in such a state of being held by the hand or hands of the user. The user holds the computer 10, for example, in the arm and performs a touch operation on the display 17 with the other hand.

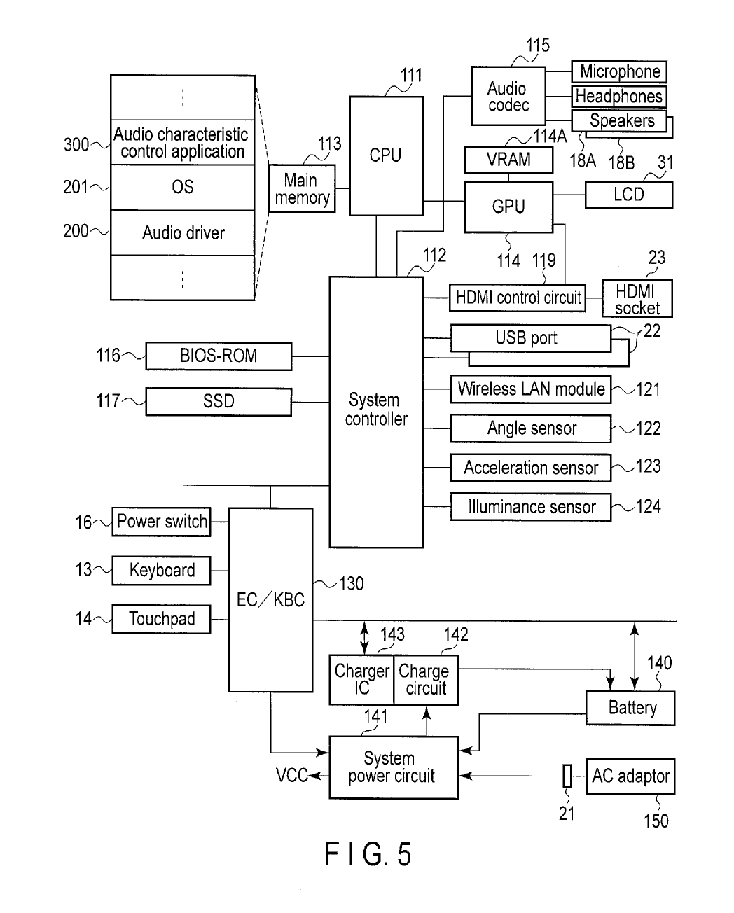

FIG. 5 illustrates the system configuration of the computer 10 of an embodiment. The computer 10 comprises, speakers 18A and 18B, a CPU 111, a system controller 112, a main memory 113, a graphics processing unit (GPU) 114, an audio codec 115, a BIOS-ROM 116, a solid state drive (SSD) 117, a wireless LAN module 121, an angle sensor 122, an acceleration sensor 123, an illuminance sensor 124, an embedded controller/keyboard controller IC (EC/KBC) 130, a charge circuit 142, a charger IC 143, and the like.

The CPU 11 is a processor configured to control the operation of each component of the computer 10. The CPU 111 executes various programs loaded from the SSD 117 to the main memory 113. The programs include an operating system (OS) 201 and various application programs. The application programs include an audio characteristic control application 300, an audio driver 200, and the like.

Further, the CPU 111 executes a basic input/output system (BIOS) stored in a non-volatile memory, namely, the BIOS-ROM 116. The BIOS is a system program for hardware control.

The GPU 114 is a display controller configured to control the LCD 17 used as a display monitor of the computer 10. The GPU 114 generates a display signal (LVDS signal) to be supplied to the LCD 17 from display data stored in a video memory (VRAM) 114A. Further, the GPU 114 can generate an HDMI video signal from display data as well. An HDMI control circuit 119 is an interface configured to transmit an HDMI video signal and a digital audio signal to an external display via, for example, an HDMI output socket provided in the body 11.

The system controller 112 is a bridge device configured to connect the CPU 111 and each component with each other. The system controller 112 comprises a built-in serial ATA controller configured to control the solid state drive (SSD) 117.

Further, the system controller 112 connects to devices such as a USB port 22 and the wireless LAN module 121.

Still further, the system controller 112 executes communication with each device connected via a bus.

The system controller 112 comprises a function of executing communication with the audio codec 115 as well. The audio codec 115 is an audio device, and in order to output audio data to the speakers 18A and 18B, the audio codec 115 comprises circuits such as a digital-to-analog converter configured to convert a digital signal into an electric signal and an amplifier configured to amplify the electric signal. Further, the audio codec 115 comprises circuits such as a microphone amplifier configured to amplify an electric signal input from a microphone and an analog-to-digital converter configured to convert the amplified electric signal into a digital signal. Note that the speakers 18A and 18B are provided, for example, on the upper surface of the body 11.

The angle sensor 122 is a sensor configured to measure an angle which the display unit 12 forms with the body 11. The acceleration sensor 123 is a sensor configured to measure the degrees of the accelerations in the directions of three axes orthogonal to each other. The orientation of the computer 10 is determined on the basis of values measured by the acceleration sensor 123. The acceleration sensor 123 is provided, for example, inside the body 11. The acceleration sensor 123 is a sensor (first sensor) configured to measure the acceleration acting on the computer 10 in a state where the computer 10 is placed. For example, when the computer 10 is used in the notebook configuration, the acceleration sensor 123 detects the accelerations in three directions, namely, the direction of the gravitational force acting when the body 11 is placed on a horizontal table (z-axis direction), the direction parallel to the short side of the body 11 (y-axis direction) and the direction parallel to the long side of the body 11 (x-axis direction).

The illuminance sensor 124 is provided, for example, in proximity to the keyboard 13 of the body 11. The illuminance sensor 124 is a sensor configured to measure the brightness of light. For example, the brightness of an LCD 17A is automatically adjusted on the basis of a value measured by the illuminance sensor 124. The illuminance sensor 124 is a sensor (first sensor) configured to measure the illuminance in the environment surrounding the computer 10.

An EC/KBC 130 is connected to the system controller 112 via a bus. Further, the EC/KBC 130 is interconnected with the charger IC 143 and a battery 140 via a serial bus.

The EC/KBC 130 is a power management controller for performing power management of the computer 10, and is realized as, for example, a single chip microcomputer comprising a built-in keyboard controller configured to control a keyboard (KB), a touchpad and the like. The EC/KBC 130 comprises a function of powering on and powering off the computer 10 based on the user's operation on a power switch 16. The EC/KBC 130 performs the control to power on and power off the computer 10 on a system power 141.

The charger IC 143 is an IC configured to control the charge circuit 142 under the control of the EC/KBC 130. The EC/KBC 130, the charger IC 143, and the system power 141 operate with power supplied from the battery 140 or from an AC adaptor 150 connected to a power-supply port 21 even while the computer 10 is powered off.

The system power 141 is configured to generate power (operation power) to be supplied to each component by using power supplied from the battery 140 or power supplied from the battery 140, power supplied from the AC adaptor 150 connected to the computer 10 as external powers, or power supplied from docker. Further, the system power 141 is configured to supply power to charge the cattery 140 by the charge circuit 142.

The charge circuit 142 is configured to charge the battery 140 using power supplied through the system power 141 by the control of the charger IC 143.

It is possible that the computer 10 is used not in the notebook configuration but in any one of the tablet configuration, the stand configuration and the tent configuration. When the computer 10 is used in a configuration such as the tablet configuration, the stand configuration or the tent configuration, which is different from a configuration (notebook configuration) where the speakers face in the normal direction, there are some cases where the volume and the audio characteristics are inappropriate depending on the direction of the speakers.

Therefore, based on a configuration in which the computer 10 is used, the computer 10 performs control to change the characteristics of sound output from the speakers 18A and 18B.

The audio characteristic control application 300 is configured to select a setting for the audio characteristics based, for example, on a value measured by the angle sensor 112 and value(s) measured by the acceleration sensor 123 and/or the illuminance sensor 124, and to notify the selected characteristic setting to the audio driver. The audio driver 200 as a correction unit is configured to correct the audio characteristics based on an instruction from the audio characteristic control application 300.

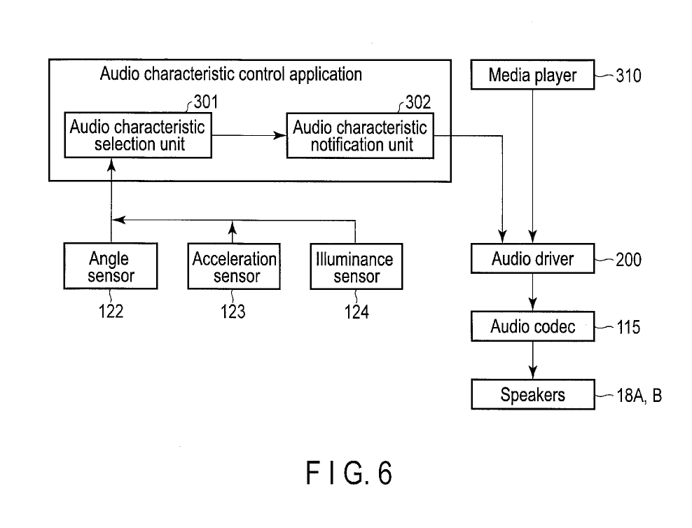

FIG. 6 is a functional block diagram showing the configuration to control the audio characteristics based on a configuration.

A media player 310 is an application program to reproduce various media such as music and video. Digital audio data reproduced by the media player 310 is supplied to the audio driver 200. The audio driver 200 supplies the digital audio data to the audio codec 115. The audio codec 115 supplies to the speakers 18A and 18B an analog audio signal obtained by D/A conversion and amplification. The speakers 18A and 18B output sound based on the analog audio signal.

The audio characteristic control application 300 comprises an audio characteristic selection unit 301, an audio characteristic notification unit 302, and the like.

The audio characteristic selection unit 301 is configured to select a setting for the characteristics of audio to be corrected by the audio driver 200 based on a value measured by the angle sensor 112 and a value measured by the acceleration sensor 123 or the illuminance sensor 124. Note that the audio characteristic selection unit 301 may select a setting for the characteristics of audio to be corrected by the audio driver 200 based on a value measured by the angle sensor 122, a value measured by the acceleration sensor 123, and a value measured by the illuminance sensor 124.

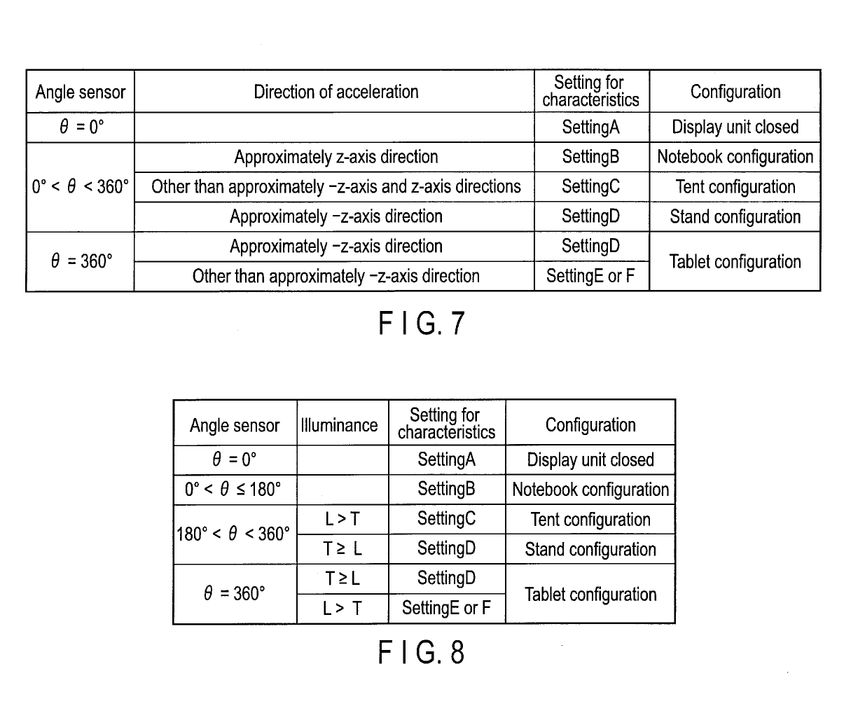

When the audio characteristic selection unit 301 selects a setting for the characteristics of audio to be corrected by the audio driver 200 based on a value measured by the angle sensor 122 and a value measured by the acceleration sensor 123, the selection of the setting of the audio characteristics is performed on the basis of the table shown in FIG. 7.

As shown in FIG. 7, in a case where a value θ measured by the angle sensor 112 is 0°, the audio characteristic selection unit 301 selects a setting A as the setting for the audio characteristics. When a value θ measured by the angle sensor 112 is 0°, the computer 10 is assumed to be in a state where the display unit 12 is closed. In this case, the volume of sound output from the speakers 18A and 18B is low, and since the surface above the speakers 18A and 18B is covered with the body 11, low-frequency sound is likely to be muffled. The setting A is such a setting as to increase the gain of an amplifier of the audio codec 115, decrease the gain in a low-frequency range, and increase the gain in a high-frequency range.

In a case where a value 9 measured by the angle sensor 122 is 0°<θ<360°, the audio characteristics are selected on the basis of the direction of the acceleration derived from values measured by the acceleration sensor 123. Note that the following descriptions are given that the direction in which the gravitational force acts when the computer is placed on a horizontal table in the notebook configuration is a z-axis direction and the direction opposite that of the gravitational force is a −z-axis direction. Further, the audio characteristics may be selected on the basis of a value in the z-axis direction measured by the acceleration sensor 123. In a case where a value in the z-axis direction measured by the acceleration sensor 123 is approximately 9.8 m/s², the body 11 is assumed to be placed on a horizontal table in such a state where the surface on the side of the keyboard 13 faces up. In a case where a value in the z-axis direction measured by the acceleration sensor 123 is approximately −9.8 m/s², the body 11 is assumed to be placed on a horizontal table in such a state where the surface on the side of the keyboard 13 faces down. For example, when a value in the z-axis direction measured by the acceleration sensor 123 is greater than 9.7 m/s², the body 11 is assumed to be placed on a horizontal plate in such a state where the surface on the side of the keyboard 13 faces up. Further, a value in the z-axis direction measured by the acceleration sensor 123 is smaller than −9.7 m/s², the body 11 is assumed to be placed on a horizontal plate in such a state where the surface on the side of the keyboard 13 faces down.

In a case where the acceleration is approximately in the z axis direction (a measured value of the acceleration in the z-axis direction is approximately 9.8 m/s²), the audio characteristic selection unit 301 selects a setting B as the setting for the audio characteristics. When the acceleration is approximately in the z-axis direction, the computer 10 is assumed to be in the notebook configuration. The setting B is such a setting as to make no change in the characteristics.

In a case where the acceleration is in a direction other than approximately the z-axis direction or the −z-axis direction (a measured value in the z-axis direction is other than approximately 9.8 or −9.8 m/s²), the audio characteristic selection unit 301 selects a setting C as the setting for the audio characteristics. When the acceleration is in a direction other than approximately the z-axis direction or the −z-axis direction (a measured value in the z-axis direction is other than approximately 9.8 or −9.8 m/s²), the computer 10 is assumed to be in the tent configuration. In this case, the speakers 18A and 18B are directed to the side opposite to the user's side, and therefore it is likely that the volume of sound output from the speakers 18A and 18B becomes low and low-frequency sound becomes insufficient. Further, the sound output from the speakers 18A and 18B are in the opposite positional relationship with respect to the user. The setting C is such a setting as to increase the gain of the amplifier of the audio codec 115 and increase the gain in a low-frequency range. Further, the setting C is such a setting as to switch the audio of the left channel and the audio of the right channel.

In a case where the acceleration is approximately in the −z axis direction (a measured value of the acceleration in the z-axis direction is approximately −9.8 m/s²), the audio characteristic selection unit 301 selects a setting D as the setting for the audio characteristics. When the acceleration is in the −z-axis direction, the computer 10 is assumed to be in the stand configuration. In this case, the surface above the speakers 18A and 18B is blocked with a table, and therefore low-frequency sound is likely to be muffled. The setting D is such a setting as to increase the gain of the amplifier of the audio codec 115, decrease the gain in a low-frequency range, and increase the gain in a high-frequency range.

In a case where a value θ measured by the angle sensor 112 is 360°, the audio characteristics are selected on the basis of the direction of the acceleration derived from values measured by the acceleration sensor 123. The computer 10 is assumed to be in the tablet configuration.

In a case where the acceleration is approximately in the −z-axis direction (a measured value of the acceleration in the z-axis direction is approximately −9.8 m/s²), the audio characteristic selection unit 301 selects the setting D as the setting of the audio characteristics. When the acceleration is approximately in the −z-axis direction, the surface above the speakers 18A and 18B is blocked with a table, and therefore low-frequency sound is likely to be muffled. The setting D is such a setting as to increase the gain of the amplifier of the audio codec 115, decrease the gain in a low-frequency range, and increase the gain in a high-frequency range.

In a case where the acceleration is in a direction other than approximately the −z-axis direction (a measured value of the acceleration in the z-axis direction is other than approximately −9.8 m/s²), the audio characteristic selection unit 301 selects a setting E or a setting F as the setting for the audio characteristics. When the acceleration is in a direction other than approximately the −z-axis direction, the computer 10 is assumed to be held by the user. In this case, it is likely that the volume of sound output from the speakers 18A and 18B becomes low and low-frequency sound becomes insufficient. Further, the sound output from the speakers 18A and 18B are in the opposite positional relationship with respect to the user. The setting E is such a setting as to increase the gain of the amplifier of the audio codec 115 and increase the gain in a low-frequency range. Further, the setting E is such a setting as to switch the audio of the left channel and the audio of the right channel. The setting F is such a setting as to increase the gain of the amplifier of the audio codec 115 and increase the gain in a low-frequency range. Further, the setting F is such a setting as not to switch the audio of the left channel and the audio of the right channel. The audio characteristic selection unit 301 may select either one of the setting E and the setting F based on a value of the acceleration in a direction (y-axis direction) parallel to the short side of the body 11 measured by the acceleration sensor 123. Further, if it is possible to obtain the orientation of the screen of the LCD 17A from the operating system 201, the audio characteristic selection unit 301 may obtain the orientation of the screen from the operating system 201 and select either one of the setting E and the setting F based on the obtained screen orientation.

When the audio characteristic selection unit 301 selects a setting for the characteristics of audio to be corrected by the audio driver 200 based on a value measured by the angle sensor 122 and a value measured by the illuminance sensor 124, the selection of a setting for the audio characteristics is performed on the basis of the table shown in FIG. 8.

As shown in FIG. 8, in a case where a value θ measured by the angle sensor 112 is 0°, the audio characteristic selection unit 301 adopts the setting A as the setting for the audio characteristics. When a value θ measured by the angle sensor 112 is 0°, this indicates that the display unit 12 is closed.

In a case where a value θ measured by the angle sensor 112 is 0°<θ<180°, the audio characteristic selection unit 301 selects the setting B as the setting for the audio characteristics. When a value θ measured by the angle sensor 112 is 0°<θ<180°, this indicates the computer 10 is used in the notebook configuration.

In a case where a value θ measured by the angle sensor 112 is 180°≦θ<360°, the audio characteristics are selected on the basis of a value (illuminance) measured by the illuminance sensor 124.

In a case where the illuminance is greater than a threshold value T, the audio characteristic selection unit 301 selects the setting C as the setting for the audio characteristics. In the case of the tent configuration, light does not directly enter the illuminance sensor 124, and therefore the illuminance measured by the illuminance sensor 124 is low. In a case where the illuminance is greater than the threshold value T, the computer 10 is assumed to be in the tent configuration. In this case, the speakers 18A and 18B are directed to the side opposite to the user's side, and therefore it is likely that the volume of sound output from the speakers 18A and 18B becomes low and low-frequency sound becomes insufficient. Further, the sound output from the speakers 18A and 18B are in the opposite positional relationship with respect to the user. The setting C is such a setting as to increase the gain of the amplifier of the audio codec 115 and increase the gain in a low-frequency range. Further, the setting C is such a setting as to switch the audio of the left channel and the audio of the right channel.

In a case where the illuminance is not greater than the threshold value, the audio characteristic selection unit 301 selects the setting D as the setting of the audio characteristics. In the case of the stand configuration, since the illuminance sensor 124 faces the supporting surface, light does not enter the illuminance sensor 124, and therefore illuminance measured by the illuminance sensor 124 becomes low. When the illuminance is not greater than the threshold value T, the computer 10 is assumed to be in the stand configuration. In this case, the surface above the speakers 18A and 18B is blocked with a table, and therefore it is likely that the volume of sound output from the speakers 18A and 18B becomes low and low-frequency sound becomes muffled. The setting D is such a setting as to increase the gain of the amplifier of the audio codec 115, decrease the gain in a low-frequency range, and increase the gain in a high-frequency range.

In a case where a value θ measured by the angle sensor 112 is 360°, the audio characteristics are selected on the basis of a value (illuminance) measured by the illuminance sensor 124.

In a case where the illuminance is not greater than the threshold value of T, the audio characteristic selection unit 301 selects the setting D as the setting for the audio characteristics. When a measured value is 360° and the illuminance is not greater than the threshold value T, the computer 10 is assumed to be placed on a table in the tablet configuration. In this case, the surface above the speakers 18A and 18B is blocked with the table, and therefore it is likely that the volume of sound output from the speakers 18A and 18B becomes low and low-frequency sound becomes muffled. The setting D is such a setting as to increase the gain of the amplifier of the audio codec 115, decrease the gain in a low-frequency range, and increase the gain in a high-frequency range.

In a case where the illuminance is greater than the threshold value T, the audio characteristic selection unit 301 selects either one of the setting E and the setting F as the setting for the audio characteristics. When a value measured by the angle sensor 122 is 360°, the computer 10 is assumed to be in the tablet configuration. In this case, it is likely that the volume of sound output from the speakers 18A and 18B becomes low and low-frequency sound become insufficient. Further, the sound output from the speakers 18A and 18B are in the opposite positional relationship with respect to the user. The setting E is such a setting as to increase the gain of the amplifier of the audio codec 115 and increase the gain in a low-frequency range. Further, the setting E is such a setting as to switch the audio of the left channel and the audio of the right channel. The setting F is such a setting as to increase the gain of the amplifier of the audio codec 115 and increase the gain in a low-frequency range. Further, the setting F is such a setting as not to switch the audio of the left channel and the audio of the right channel. The audio characteristic selection unit 301 may select either one of the setting E and the setting F based on a value of the acceleration in the y-axis direction of the body 11 measured by the acceleration sensor 123. Further, if it is possible to obtain the orientation of the screen of LCD 17A from the operating system 201, the audio characteristic selection unit 301 may select either one of the setting E and the setting F based on the screen orientation obtained from the operating system 201.

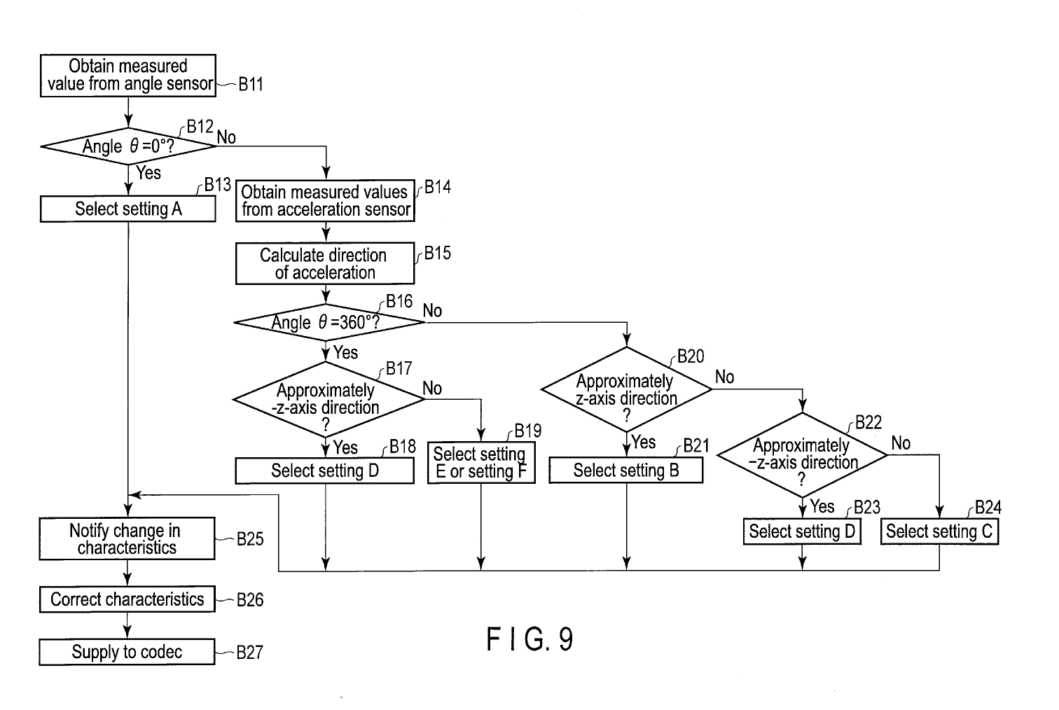

Next, the process from obtaining values measured by sensors (angle sensor 122 and acceleration sensor 123) to performing audio correction will be described. FIG. 9 is a flowchart showing the process from obtaining measured values from the sensors by the audio characteristic selection unit 301 to outputting sound from the speakers.

The audio characteristic selection unit 301 obtains a measured value (angle) from the angle sensor 122 (step B11). The audio characteristic selection unit 301 determines whether the obtained angle is 0° (step B12). If it is determined to be 0° (Yes in step B12), the audio characteristic selection unit 301 selects the setting A (step B13).

If it is determined not to be 0° (No in step B12), the audio characteristic selection unit 301 obtains values (degrees of the accelerations in three axes directions) measured by the acceleration sensor 123 (step B14). The audio characteristic selection unit 301 derives the direction of the acceleration from the degrees of the accelerations in three axes directions (step B15).

The audio characteristic selection unit 301 determines whether the angle obtained in step B11 is 360° (step B16). If it is determined to be 360° (Yes in step B16), the audio characteristic selection unit 301 then determines whether the acceleration is the −z-axis direction (step B17). If it is determined to be in the −z-axis direction (Yes in step B17), the audio characteristic selection unit 301 selects the stetting D (step B18). If it is determined not to be in the −z-axis direction (No in step B17), the audio characteristic selection unit 301 selects either one of the setting E and the setting F based on a measure value of the acceleration in the y-axis direction of the body 11 or on the orientation of the screen (step B19).

If it is determined to be 360° in step B16 (No in step B16), the audio characteristic selection unit 301 then determines whether the acceleration is in the z-axis direction (step B20). If it is determined to be in the z-axis direction (Yes in step B20), the audio characteristic selection unit 301 selects the setting B (step B21).

If it is determined not to be in the z-axis direction (No in step B20), the audio characteristic selection unit 301 then determines whether the acceleration is in the −z-axis direction (step B22). If it is determined to be in the −z-axis direction (Yes in step B22), the audio characteristic selection unit 301 selects the setting D (step B23). If it is determined not to be in the −z-axis direction (No in step B22), the audio characteristic selection unit 301 selects the setting C (step B24).

After selecting a setting, the audio characteristic selection unit 301 notifies the selected setting to the audio characteristic notification unit 302. The audio characteristic notification unit 302 notifies the selected setting to the audio driver 200 (step B25). The audio driver 200 corrects digital audio data supplied from the media player based on the notified setting (step B26). The audio driver 200 supplies the corrected digital audio data to the audio codec 115 (step B27).

The audio codec 115 converts the digital audio data to an analog audio signal. The audio codec 115 amplifies the converted analog signal and supplies the amplified analog audio signal to the speakers 18A and 18B. The speakers 18A and 18B output sound corresponding to the corrected digital audio data.

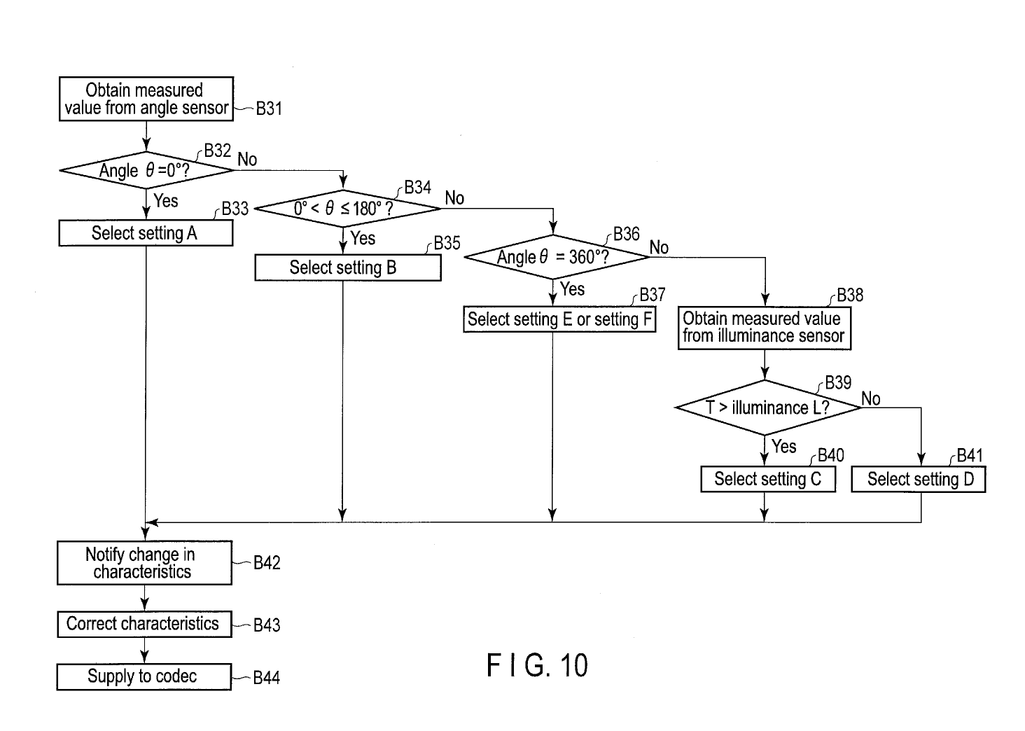

Next, the process from obtaining measured values from sensors (angle sensor 122 and illuminance sensor 124) to performing audio correction will be described. FIG. 10 is a flowchart showing the process from obtaining measured values from the sensors by the audio characteristic selection unit 301 to outputting sound from the speakers.

The audio characteristic selection unit 301 obtains a measured value (angle) from the angle sensor 122 (step B31). The audio characteristic selection unit 301 determines whether the obtained angle θ is 0° (step B12). If it is determined to be 0° (Yes in step B32), the audio characteristic selection unit 301 selects the setting A (step B33).

If it is determined not to be 0° (No in step B32), the audio characteristics unit 301 then determines whether the obtained angle θ satisfies a condition 0°<θ≦180° (step B34). If it is determined to satisfy the condition 0°<θ≦180° (Yes in step B34), the audio characteristic selection unit 301 selects the setting B (step B35). If it is determined not to satisfy the condition 0°<θ≦180° (No in step B34), the audio characteristic selection unit 301 then determines whether the angle θ obtained from the angle sensor 122 is 360° (step B36). If the angle θ is determined to be 360° (Yes in step B36), the audio characteristic selection unit 301 selects either one of the setting E and the setting F based on a measured value of the acceleration in the y-axis direction of the body 11 or on the orientation of the screen (step B37).

If the angle θ is determined not to be 360° (No in step B36), the audio characteristic selection unit 301 obtains a measured value (illuminance L) from the illuminance sensor 124 (step B38). The audio characteristic selection unit 301 then determines whether the illuminance L is lower than the threshold value T (step B39). If the illuminance L is determined to be lower than the threshold value T (Yes in step B39), the audio characteristic selection unit 301 selects the setting C (step B40). If the illuminance L is determined not to be lower than the threshold value T (No in step B39), the audio characteristic selection unit 301 selects the setting D (step B41).

After selecting a setting, the audio characteristic selection unit 301 notifies the selected setting to the audio characteristic notification unit 302. The audio characteristic notification unit 302 notifies the selected setting to the audio driver 200 (step B42). The audio driver 200 corrects digital audio data supplied from the media player based on the notified setting (step B43). The audio driver 200 supplies the corrected digital audio data to the audio codec 115 to output sound from the speakers (step B44).

The audio codec 115 converts the digital audio data to an analog audio signal. The audio codec 115 amplifies the converted analog audio signal and supplies the amplified analog audio signal to the speakers 18A and 18B. The speakers 18A and 18B output sound corresponding to the corrected digital audio data.

As described above, based on an angle measured by the angle sensor 122 and value(s) measured by the acceleration sensor 123 and/or the illuminance sensor 124, digital audio data is corrected and sound corresponding to the corrected digital audio data is output. In this way, even in a case where the positional relationship between the user and the speakers varies, it becomes possible to ease the difficulties for the user in hearing the sound output from the speakers.

Note that the various kinds of processing in the present embodiments can be realized by a computer program, and therefore an effect similar to those produced in the present embodiments can be easily realized simply by installing the computer program in a computer via a computer readable storage medium storing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a body;
a display attached to the body configured to rotate between a state of covering a front surface of the body and a state of covering a back surface of the body, wherein the electronic device is placed in multiple configurations;
an angle sensor to measure an angle between the front surface and the display;
a first sensor to detect a configuration of the electronic device being placed;
a processor to correct digital audio data based on the angle measured by the angle sensor and the configuration detected by the first sensor; and
speakers to output sound corresponding to the corrected digital audio data.

2. The device of claim 1, wherein the processor changes a gain in a specific frequency.

3. The device of claim 1, wherein the processor switches audio of a left channel and audio of a right channel.

4. The device of claim 1, wherein the first sensor comprises an illuminance sensor to measure illuminance and/or an acceleration sensor to measure degrees of accelerations in three axes orthogonal to each other.

5. A method of controlling an electronic device, the electronic device comprising a body, a display attached to the body to rotate between a state of covering a front surface of the body and a state of covering a back surface of the body, wherein the electronic device is placed in multiple configurations, the method comprising:
measuring an angle between the front surface of the body and the display;
detecting a configuration of the device being placed;
correcting digital audio data based on the angle and the state; and
outputting sound corresponding to the corrected digital audio data from the speakers.

6. The method of claim 5, wherein the correction comprises changing a gain in a specific frequency.

7. The method of claim 5, wherein the correction comprises switching audio of a left channel and audio of a right channel.

8. The method of claim 5, wherein the detection of the configuration comprises an illuminance measurement and/or acceleration measurement in three axes orthogonal to each other.

9. A non-transitory computer readable storage medium configured to store a computer program which is executable by a computer, the computer comprising a body, a display attached to the body to rotate between a state of covering a front surface of the body and a state of covering a back surface of the body, wherein the electronic device is placed in multiple configurations, the computer program controlling the computer to execute functions of:
measuring an angle between the front surface of the body and the display;
detecting a configuration of the device being placed;
correcting digital audio data based on the angle and the state; and
outputting sound corresponding to the corrected digital audio data from the speakers.

10. The medium of claim 9, wherein the correction comprises changing a gain in a specific frequency.

11. The medium of claim 9, wherein the correction comprises switching audio of a left channel and audio of a right channel.

12. The medium of claim 9, wherein the detection of the configuration comprises an illuminance measurement and/or an acceleration measurement in three axes orthogonal to each other.
